(19) United States
(12) Patent Application Publication
(10) Pub. No.: US 2004/0252455 A1
(43) Pub. Date: Dec. 16, 2004

(54) Computer cooling system with fan

(76) Inventor: Kuo Yi-Lung, Keelung (TW)

Correspondence Address: FENWICK & WEST LLP, SILICON VALLEY CENTER, 801 CALIFORNIA STREET, MOUNTAIN VIEW, CA, 94041, US

(21) Appl. No.: 10/767,415

(22) Filed: Jan. 28, 2004

Related U.S. Application Data
(60) Provisional application No. 60/456,643, filed on Mar. 20, 2003.

(51) Int. Cl. G06F 1/20

(52) U.S. Cl. 361/687

(57) ABSTRACT

To dissipate heat generated by components inside a personal computer, a fan is configured to blow cool air from outside a computer chassis to components on the inside of the chassis. The air is heated by the components and exits the computer chassis through a number of air outlets in the chassis. The fan can be mounted, for example, on a wall of a computer chassis, and may have a filter in the airflow path to remove particles in the air before it enters the chassis.

### CROSS REFERENCE TO RELATED APPLICATIONS

This application claims the benefit of U.S. Provisional Application No. 60/456,643, filed Mar. 20, 2003, which is hereby incorporated in its entirety by reference.

### BACKGROUND

1. Field of the Invention

The invention relates to cooling systems for personal computers, and in particular to cooling systems that use fans to direct a flow of air over electrical components of a computer to cool them.

2. Background of the Invention

Computers have found wide applications in our lives and industries, and the development of computers has greatly increased efficiency. But as computers offer more extensive capabilities and operate at higher speeds than ever, the electronic elements inside the chassis of the computer—the CPU in particular—generate more heat. This is particularly true for the central processing unit (CPU) in the computer, but other elements around CPUs may also produce a significant amount of heat. If this heat is not exhausted from the computer chassis, the performance of the components can be compromised due to the resulting high temperatures. Moreover, for small form factor computers, the cooling problem is even more acute.

For these reasons, computers are normally equipped with a cooling system, one example of which is a discharge fan configured to exhaust hot air from inside the computer chassis. Although such a configuration offers the basic cooling function, exhaust fans can result in vortexes or even turbulent currents inside the chassis. Vortexes and turbulent currents can lead to hot spots within the chassis, which diminishes the cooling ability of exhaust fans.

### SUMMARY OF THE INVENTION

In view of the deficiencies of existing cooling systems, a cooling system for a personal computer reverses the fan direction of the typical exhaust fan, blowing air into the computer rather than directly exhausting it from the computer. By directing an air current into the computer chassis, hot air is exhausted throughout the many air outlets in a typical computer chassis. This avoids the vortexes, turbulence, and other cooling inefficiencies caused by exhaust fans.

In one embodiment, a cooling system for a personal computer includes a computer chassis, a motherboard, and a fan. The motherboard is mounted inside the computer chassis and is used to couple a number of electronic components, which generate heat during operation. The fan is mechanically coupled to the computer chassis and configured to direct an airflow through the fan from outside the computer chassis to inside the computer chassis, the air flow cooling the electronic components. In this way, cool air outside the chassis is directed inside the chassis and over the hot electrical components on the motherboard, cooling them. The heated air is then forced out of the chassis through air outlets in the chassis due to the pressure created by the fan blowing additional cool air from outside the chassis into the chassis.

In one embodiment, the computer chassis includes a plurality of air outlets located far from to electronic components on the motherboard that generate a relatively large amount of heat, thereby avoiding a hotter air flow near those components. Alternatively or in addition, these air outlets are located near elements on the motherboard for which less heat dissipation is desired, thereby causing a hotter air flow near those elements.

In another embodiment, the cooling system includes a filter that is mounted in a path of the airflow from the fan. In this way, the filter removes particles from air outside the computer chassis before the air is blown inside the computer chassis.

### BRIEF DESCRIPTION OF THE DRAWINGS

FIG. 1 illustrates a cooling system for a personal computer and the air currents inside the computer's chassis, in accordance with one embodiment of the invention.

### DETAILED DESCRIPTION OF THE PREFERRED EMBODIMENTS

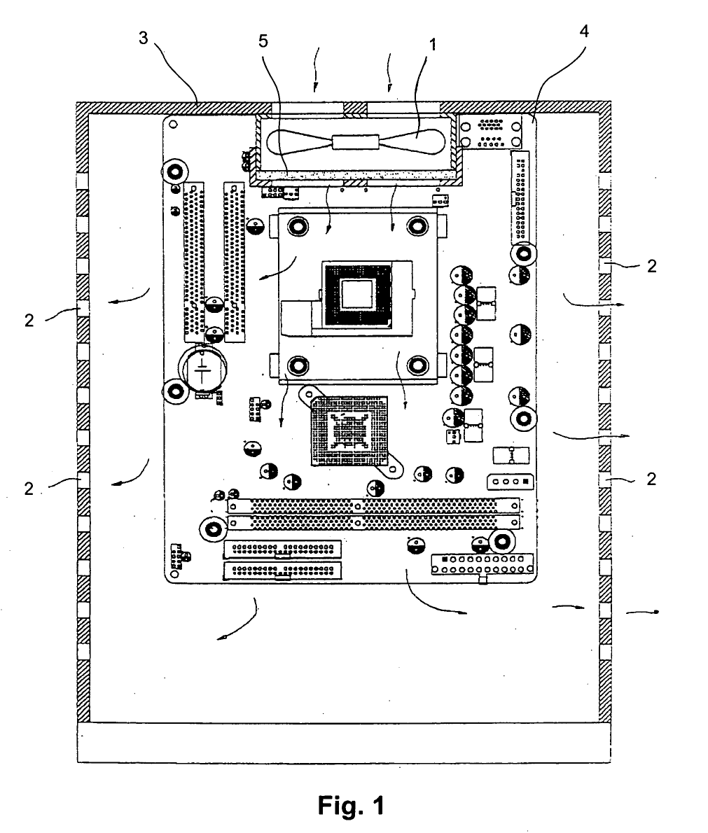

FIG. 1 shows a plan view of a personal computer equipped with a cooling system in accordance with an embodiment of the invention. The computer comprises a chassis 3, inside of which is mounted a motherboard 4. As is well known in the art, the motherboard 4 couples a number of electronic components of the computer, such as the CPU, the chipset, memory, PCI cards, and a number of other electrical components. During operation of the computer, these components can generate a nontrivial amount of heat, which tends to raise the temperature of the inside of the computer and thus of the components themselves. This, in turn, degrades performance of the electrical components.

To cool the components on the motherboard 4, a fan 1 is coupled to the computer chassis 3. In one embodiment, the fan 1 is mounted directly to a wall of the chassis 3, such as the rear wall as shown in the figure. Rather than exhaust air directly out of the computer chassis 3, the fan 1 is configured to blow air through the fan 1 directly into the chassis 1. This helps to avoid the vortexes and currents that can occur with exhaust systems. The cool air is directed over heat-generating elements on the motherboard 4, where the air dissipates heat therefrom. The heated air then exits the chassis 3 through a number of openings in the chassis 3, such as air outlets 2. The arrows in FIG. 1 illustrate and example of the air flow inside the chassis 3, in accordance with an embodiment of the invention.

A filter 5 may further be mounted in a path of the airflow from the fan 1. In this way, the filter 5 removes particles that would otherwise be carried in the air from outside the computer chassis 3. This contributes to the reliability of the computer, as particles in the air such as dust may gather over the components over time and thus cause poor cooling or otherwise diminish the operation of the computer. The filter 5 works especially well in combination with the cooling system described herein. In exhaust systems, air enters the computer chassis through all of the openings of the chassis and then exits through the fan; therefore, it may be impractical to filter the air before it is blown inside the computer. But in the cooling system of the present invention, the air flow into the chassis 3 can be easily directed through the filter 5, thereby catching most of the particles before they enter the chassis 3.

In one embodiment, the fan is oriented to face a CPU mounted on the motherboard 4, so that the fan 1 blows air directly over the CPU. This helps to maximize the cooling of the CPU, usually the most critical and one of the hottest components on the motherboard 4. Alternatively, the fan 1 may be oriented to blown directly towards one or more other high heat-generating components.

As described above, because the chassis 3 is not normally air tight, the heated air exits the chassis 3 through any of a number of air outlets therein. However, by intentionally creating one or more air outlets 2 in the chassis 3, the bulk of the air inside the chassis 3 can be directed through those air outlets 2 instead of through other openings in the chassis 3. Air that enters the chassis 3 tends to heat up due to the hot electrical components inside the chassis. Therefore, the air is typically at its hottest just before it leaves the chassis 3. Some elements on the motherboard 4 should be kept relatively hot, like heating elements such as capacitors, while others should be kept as cool as possible, like a CPU or a graphics card. Accordingly, in one embodiment, the chassis 3 includes one or more air outlets 2 that are located near elements that should be kept relatively hot, and located relatively far from components that should be cooled. This helps to direct the relatively hotter air near heating elements and away from electrical components in the computer that should be cooled.

It has been found that the temperature inside a computer equipped with an embodiment of the cooling system described herein is 10° C. lower than the temperature that is achieved with an exhaust-based cooling system.

The foregoing description of the embodiments of the invention has been presented for the purposes of illustration and description. It is not intended to be exhaustive or to limit the invention to the precise forms disclosed. Persons skilled in the relevant art can appreciate that many modifications and variations are possible in light of the above teaching. It is therefore intended that the scope of the invention be limited not by this detailed description, but rather by the claims appended hereto.

I claim:

1. A cooling system for a personal computer, the cooling system comprising:
a computer chassis;
a motherboard mounted inside the computer chassis, the motherboard for coupling a number of electronic components that generate heat during operation, and
a fan mechanically coupled to the computer chassis and configured to direct an airflow through the fan from outside the computer chassis to inside the computer chassis, the air flow cooling the electronic components.

2. The cooling system of claim 1, wherein the fan is mounted on a wall of the computer chassis.

3. The cooling system of claim 1, further comprising:
a motherboard with a socket for receiving a CPU;
wherein the fan is configured to blow air directly towards the socket from outside the computer chassis.

4. The system of claim 1, further comprising:
a filter mounted in a path of an airflow from the fan, the filter for removing particles from air outside the computer chassis before being blown inside the computer chassis.

5. The system of claim 1, wherein the computer chassis includes a plurality of air outlets located far from electronic components on the motherboard that generate a relatively large amount of heat, thereby avoiding a hotter air flow near those components.

6. The system of claim 1, wherein the computer chassis includes a plurality of air outlets located near elements on the motherboard for which less heat dissipation is desired, thereby causing a hotter air flow near those elements.
